(19) United States
(12) Patent Application Publication
(10) Pub. No.: US 2002/0002410 A1
(43) Pub. Date: Jan. 3, 2002

(54) Information acquisition method and apparatus

(75) Inventors: Naoki Tomita, Ome-shi (JP); Tomio Sakata, Ome-shi (JP)

Correspondence Address: Finnegan, Henderson, Farabow,, Garrett & Dunner, L.L.P., 1300 I Street, N.W., Washington, DC, 20005-3315, US

(73) Assignee: Kabushiki Kaisha Toshiba

(21) Appl. No.: 09/797,676

(22) Filed: Mar. 5, 2001

(30) Foreign Application Priority Data
Jun. 30, 2000 (JP) 2000-197585

(51) Int. Cl. G05B 11/32

(52) U.S. Cl. 700/67

(57) ABSTRACT

The present invention is directed to detecting information such as characters or the like formed on a form using fluorescent ink without using any special components such as a light source for emitting ultraviolet light, an optical filter for intercepting transmission of ultraviolet light, or the like. When visible light which is emitted by fluorescent ink excited upon being irradiated with ultraviolet rays is detected by an image sensor, a level of the output photoelectrically converted by the image sensor is saturated and assures a level higher than white level as white reference, so that information such as characters or the like formed on a form using fluorescent ink can be acquired.

### CROSS-REFERENCE TO RELATED APPLICATIONS

This application is based upon and claims the benefit of priority from the prior Japanese Patent Application No. 2000-197585, filed Jun. 30, 2000, the entire contents of which are incorporated herein by reference.

### BACKGROUND OF THE INVENTION

The present invention relates to an information acquisition method and apparatus, which is capable of acquiring information such as characters, barcodes, marks, figures (images), or the like formed on a form using fluorescent ink which is excited upon being irradiated with ultraviolet light and emits visible light having a wavelength different from the irradiated ultraviolet light in, e.g., an optical character reader (to be referred to as an OCR hereinafter).

Conventionally, in order to read characters, marks or the like formed using fluorescent ink on a form by an OCR, a light source for emitting ultraviolet light, an optical filter for intercepting transmission of ultraviolet light and transmitting light emitted by the fluorescent ink upon being irradiated with the ultraviolet light, and a photosensor are provided in addition to a light source and photosensor originally equipped in the OCR, as disclosed by Jpn. Pat. Appln. KOKAI Publication No. 6-96298. In the OCR, characters, marks, or the like formed using the fluorescent ink are detected by detecting light transmitted through the optical filter by the photosensor such as a CCD (charge coupled device) or the like.

In this manner, upon detecting characters, marks, or the like formed on a form using fluorescent ink by the conventional OCR, the dedicated light source for emitting ultraviolet light, optical filter, and photosensor must be added, resulting in a complicated and bulky apparatus.

### BRIEF SUMMARY OF THE INVENTION

Accordingly, it is an object of the present invention to provide an information acquisition method and apparatus, which is capable of detecting characters, marks, or the like formed using fluorescent ink without using any special components such as a light source for emitting ultraviolet light, an optical filter for intercepting transmission of ultraviolet light, or the like, and acquiring information such as characters, barcodes, marks, figures (images), or the like formed on a form using fluorescent ink.

According to one aspect of the present invention, there is provided a method of acquiring information from a form on which the information is recorded using fluorescent ink, comprising the steps of: irradiating the form with light which is emitted by a white light source, the light containing near ultraviolet light; outputting an analogue signal according to an amount of light reflected by the form; converting the output analogue signal into a multi-level digital signal; detecting from the digital signal a reference level of the digital signal corresponding to a position of the form where no information is recorded; and comparing a level of the digital signal corresponding to the information recorded using fluorescent ink with the reference level, and binarizing the digital signal based on a result of the comparison to obtain image information.

According to another aspect of the present invention, there is provided an apparatus for acquiring information from a form on which the information is recorded using fluorescent ink, comprising: a white light source for irradiating the form with light containing near ultraviolet light; photoelectric conversion means for outputting an analogue signal according to an amount of light reflected by the form; A/D conversion means for converting the output analogue signal into a multi-level digital signal; reference level detection means for detecting from the digital signal a reference level of the digital signal corresponding to a position of the form where no information is recorded; and binarization means for comparing a level of the digital signal corresponding to the information recorded using fluorescent ink with the reference level, and binarizing the digital signal based on a result of the comparison to obtain image information.

According to still another aspect of the present invention, there is provided a character recognition apparatus for recognizing characters from a form on which the characters are recorded using fluorescent ink, comprising: a white light source for irradiating the form with light containing near ultraviolet light; photoelectric conversion means for outputting an analogue signal according to an amount of light reflected by the form; A/D conversion means for converting the output analogue signal into a multi-level digital signal; reference level detection means for detecting from the digital signal a reference level of the digital signal corresponding to a position of the form where no information is recorded; binarization means for comparing a level of the digital signal corresponding to the information recorded using fluorescent ink with the reference level, and binarizing the digital signal based on a result of the comparison to output image information; and recognizing means for recognizing the form as being recorded using the fluorescent ink based on the image information output from the binarization means.

According to still another aspect of the present invention, there is provided a character recognition apparatus for reading characters from a form on which the characters are recorded and recognizing the read character, comprising: determining means for determining whether or not one of a character and a mark is recorded on a form using the fluorescent ink; and rejecting the form in a case where the determining means determines that the one of the character and mark is recorded on the form using the fluorescent ink.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a view for explaining processes in an embodiment of the present invention;

FIG. 2 is a view for explaining limit character recognition target areas with marks of the fluorescent ink;

FIG. 3 is a schematic view showing the arrangement of a scanner apparatus used in the embodiment of the present invention;

FIG. 4 is a view showing the arrangement of a color image sensor;

FIG. 5 is a block diagram showing the arrangement of a processing circuit in the embodiment of the present invention;

FIG. 6 is a flow chart for explaining an operation in the embodiment of the present invention;

FIG. 7 is a flow chart for explaining a detailed operation including steps for the fluorescent ink detection;

FIG. 8 is a flow chart for explaining details of step S5 in FIG. 7;

FIG. 9 is a graph showing the waveform of the output signal from a color image sensor before shading correction;

FIG. 10 is a graph showing the waveform of the output signal from a color image sensor after shading correction; and

FIG. 11 is a graph showing the white level of the sheet surface of a form.

### DETAILED DESCRIPTION OF THE INVENTION

An embodiment of the present invention will be described hereinafter with reference to the accompanying drawings. The embodiment to be described below will exemplify a case wherein the present invention is applied to an OCR.

First, a numbering print technique and a technique of limiting character recognition target areas using fluorescent ink will be described below.

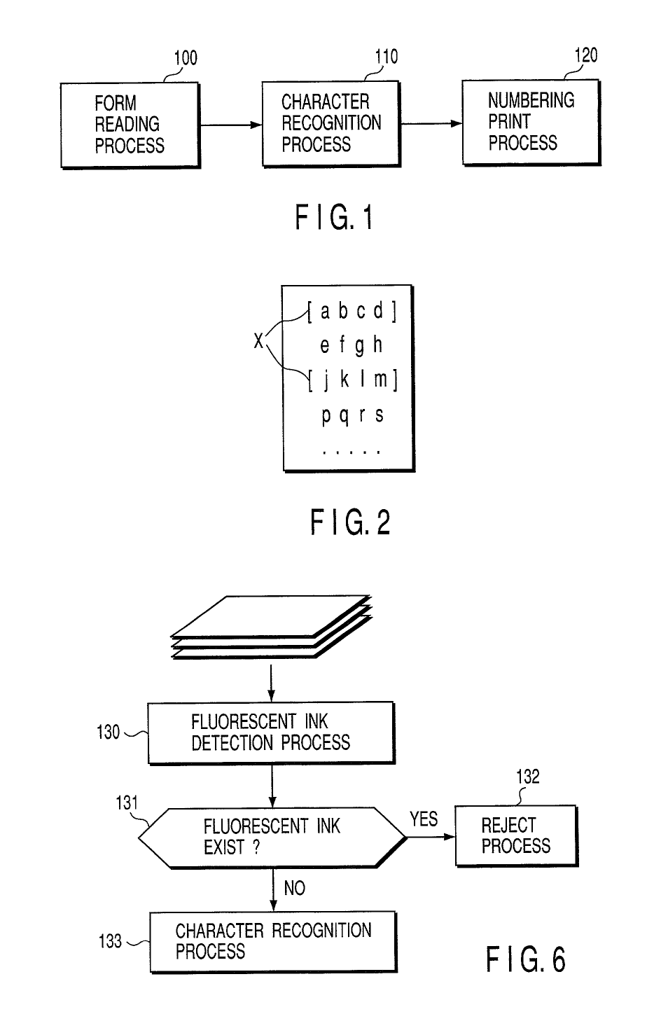

As shown in FIG. 1, characters written on a form are read by a form reading process 100, and character recognition is executed by a character recognition process 110. The printing for numbering is executed on the form that has been effected a character recognition process in order to differentiate from a form that is not yet effected a character recognition process. That is, conventional numbering print has executed onto vacant areas (i.e., plain areas where no character is written) of a form using a specific color (e.g., red), whereas in this embodiment, the printing for numbering is executed using colorless fluorescent ink by a numbering print process 120. Such the numbering print using colorless fluorescent ink would not make the form dirty as an advantage.

However, the colorless fluorescent ink on the form is invisible to a human, resulting in a problem that it is not easy to determine whether or not each form has already been effected a character recognition process. This embodiment resolves the above problem.

Apart from the numbering print process, as shown in FIG. 2, it may be useful to limit character recognition target areas by printing, e.g., marks X of the fluorescent ink for one or more target lines to be read of a plurality of character lines on a form.

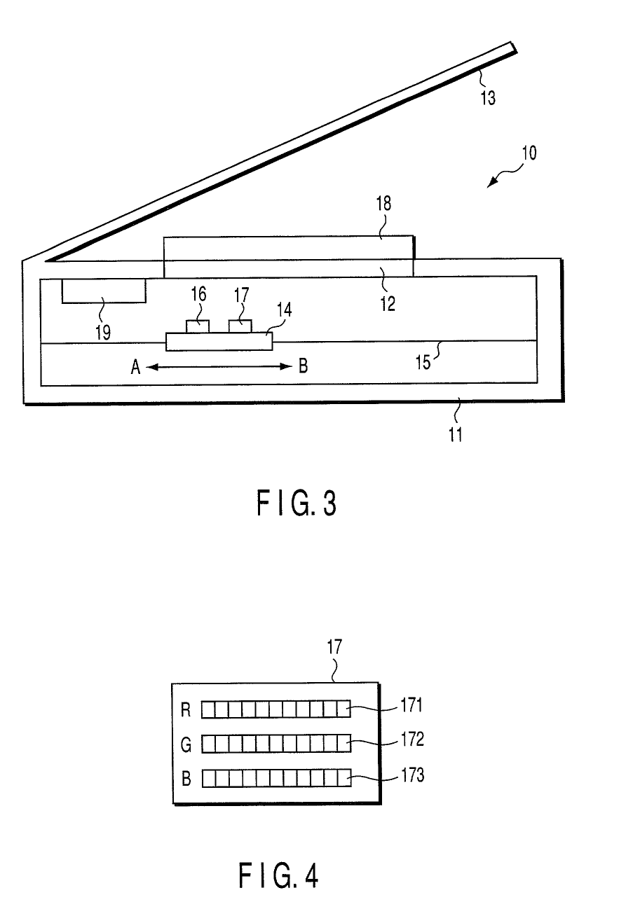

FIG. 3 is a schematic view of the mechanism of a scanner apparatus used in this embodiment. A scanner apparatus 10 shown in FIG. 3 is of a flatbed type, and has a housing 11 with a transparent glass 12 on which a form 18 to be read is placed, and a cover 13. An optical head 14 is arranged inside the housing 11, and moves along a rail 15 in the directions of arrows A and B by a driving motor such as a stepping motor (not shown), which is controlled by a control circuit (not shown).

The optical head 14 is provided with a white light source 16 for emitting visible light falling within the wavelength range from 400 nm to 700 nm, and a color image sensor 17. Light emitted by the white light source 16 is reflected by the form 18 placed on the glass 12, and is detected by the color image sensor 17 of the optical head 14. The color image sensor 17 is provided as a photoelectric conversion means. As the white light source 16, a light source used as that for a conventional OCR may be used. The white light source 16 also emits near ultraviolet light. The wavelength of near ultraviolet light emitted by the white light source 16 falls within the range from 400 nm to 450 nm.

As the color image sensor 17, a commercially available CCD image sensor is used. The color image sensor 17 includes three line image sensors 171, 172, and 173 for respectively detecting three primary color light components R, G, and B, as shown in FIG. 4.

The line image sensor 171 is formed by arranging a plurality of photodetection elements on one line. The line image sensor 171 detects a red (R) light component of incoming light reflected by the form 18, and photoelectrically converts the detected red (R) light to output an output voltage (analog signal) corresponding to the detected red (R) light component.

The line image sensor 172 is formed by arranging a plurality of photodetection elements on one line. The line image sensor 172 detects a green (G) light component of incoming light reflected by the form 18, and photoelectrically converts the detected green (G) light to output an output voltage (analog signal) corresponding to the detected green (G) light component.

The line image sensor 173 is formed by arranging a plurality of photodetection elements on one line. The line image sensor 173 detects a blue (B) light component of incoming light reflected by the form 18, and photoelectrically converts the detected blue (B) light to output an output voltage (analog signal) corresponding to the detected blue (B) light component.

The line image sensor 171 includes an optical filter for transmitting red light alone to detect the red light. Likewise, the line sensor 172 includes an optical filter for transmitting green light alone. The line image sensor 173 includes an optical filter for transmitting blue light alone.

A white reference plate 19 is provided inside the housing 11, and has a surface that opposes the optical head 14 and is painted in white. The white reference plate 19 is used for shading correction and white correction of an output voltage output from the color image sensor 17.

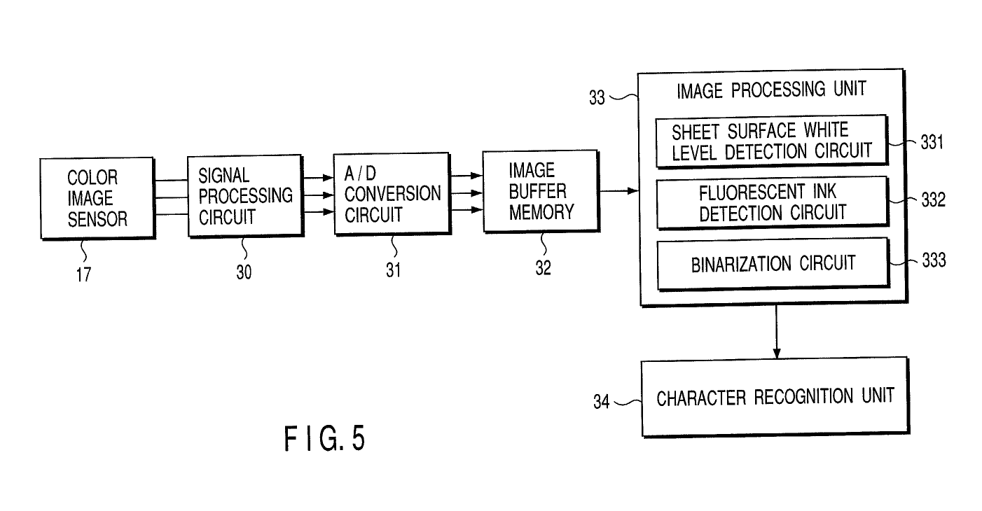

FIG. 5 is a block diagram showing the arrangement of a processing circuit in this embodiment.

Upon receiving light reflected by the form 18, the color image sensor 17 outputs to a signal processing circuit 30 output voltages (analog signals) obtained by detecting and photoelectrically converting red (R), green (G), and blue (B) color components in the reflected light. The signal processing circuit 30 has variable-gain amplifiers for amplifying input signals, and amplifies and outputs the output voltages (analog signals) input from the color image sensor 17 to an analog-to-digital conversion circuit (to be referred to as an A/D conversion circuit hereinafter) 31. The signal processing circuit 30 implements shading correction and white correction of input voltages (analog signals) by controlling the gains of the amplifiers. Details of shading correction and white correction will be described later.

The A/D conversion circuit 31 converts the output voltages (analog signals) of red (R), green (G), and blue (B) color components input from the signal processing circuit 30 into digital data defined by 256 levels ranging from 0 to 255, and outputs the digital data to an image buffer memory 32. The 256-level digital data can be expressed by an 8-bit signal.

The image buffer memory 32 stores digital data for one form output from the A/D conversion circuit 31 as form image data indicating an image of the form. An image processing unit 33 processes form image data stored in the image buffer memory 32. The image processing unit 33 has a sheet surface white level detection circuit 331, fluorescent ink detection circuit 332, and binarization circuit 333.

A character recognition unit 34 performs character recognition of a binary image obtained by binarizing the form image data stored in the image buffer memory 32 by the binarization circuit 333 in the image processing unit 33, and outputs character codes as a recognition result.

It is to be noted that character recognition target areas may be limited on a form using fluorescent ink as shown in FIG. 2 and corresponding character recognition target lines may be identified on an image acquired from the fluorescent ink detection circuit 332, so that only the binarized image of the character recognition target lines is recognized.

The character codes output from the character recognition unit 34 are recorded in a recording device such as an HDD (hard disk drive) or the like. A character recognition function of the character recognition unit 34 may be implemented using a conventional one.

The OCR in this embodiment includes the scanner apparatus for capturing an image of the form, and a character recognition apparatus for recognizing character images included in the form image output from the scanner apparatus. The OCR may be realized by arranging the scanner and character recognition apparatuses either in a single housing or in independent housings. The character recognition apparatus may be implemented as either a dedicated apparatus including dedicated circuits or a program (software) which executes a character recognition process and is installed in a personal computer. In FIG. 5, the color image sensor 17, signal processing circuit 30, and A/D conversion circuit 31 are included in the scanner apparatus. On the other hand, the image buffer memory 32, image processing unit 33, and character recognition unit 34 are included in the character recognition apparatus.

An operation of this embodiment will be described below using the flow chart shown in FIG. 6.

A fluorescent ink detection process is executed on the forms on which the printing for numbering has been effected using fluorescent ink and the forms on which character recognition target areas have been limited by printing marks using fluorescent ink (step 130). If it is detected that the printing for numbering has been effected to a form (YES in step 131), this form is rejected from the targets because a character recognition process for this form has already been completed (step 132). On the other hand, if it is NO in step 131 and one or more character recognition target areas (one or more target lines) with fluorescent ink are detected, a character recognition process for the detected lines is executed (step 133).

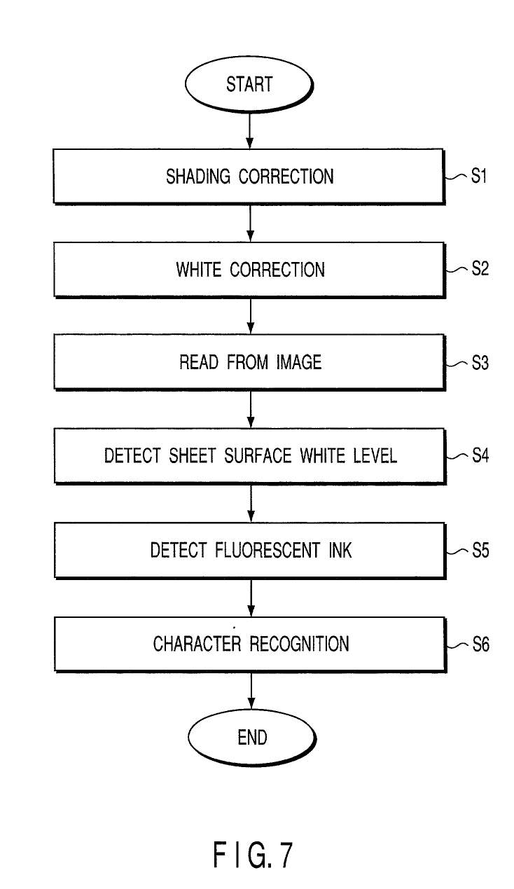

Next, a detailed operation including steps for the fluorescent ink detection will be described below using the flow chart shown in FIG. 7.

A case will be exemplified below wherein an image of the form 18, on which characters are printed using transparent fluorescent ink which is excited by near ultraviolet rays having a wavelength of, e.g., 450 nm, and emits light having a wavelength of 650 nm, is captured by the scanner apparatus, and images of the characters formed using the fluorescent ink undergo character recognition.

In step S1, the optical head 14 is moved to a position opposing the white reference plate 19, and shading correction is done for output voltages respectively output from the line image sensors 171, 172, and 173.

Shading correction adjusts the gains in the signal processing circuit 30 so that output voltages output from all photodetection elements of the color image sensor assume identical values when light emitted by the white light source 16 and reflected by the white surface of the white reference plate 19 is input to the line image sensors. The reason why such shading correction is required will be explained below.

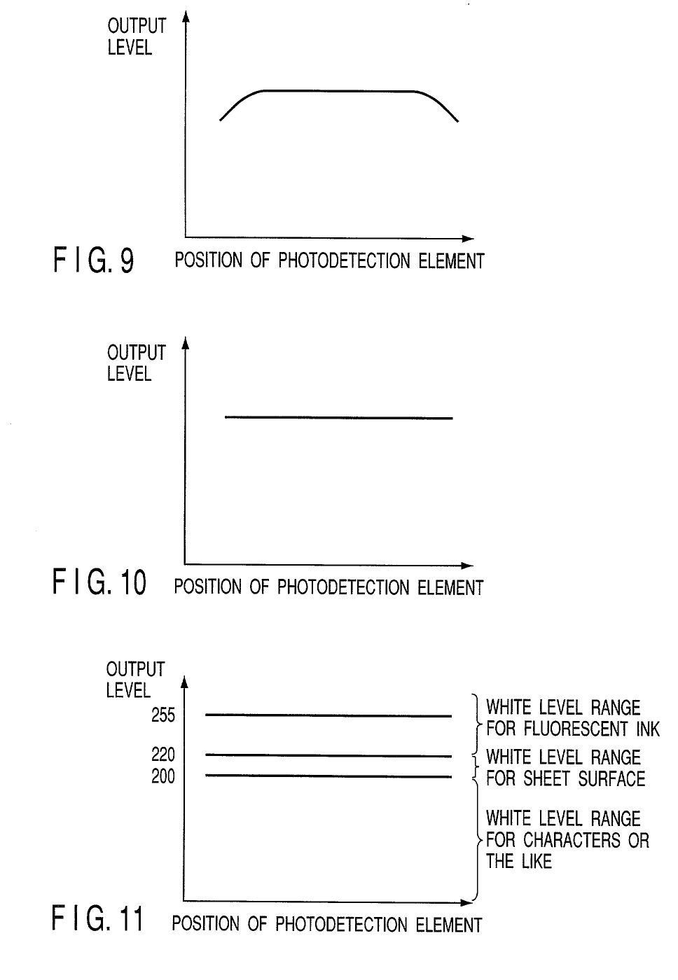

In general, when light emitted by the white light source 16 and reflected by the white surface of the white reference plate 19 is input to a color line image sensor, output voltages output from all the photodetection elements of the color line image sensor do not assume identical values, and output voltages from end photodetection elements of those arranged in a line become lower than those output from central photodetection elements. This is caused by light source nonuniformity (distortion) and the characteristics of the color line image sensor. In the graph shown in FIG. 9, the X-axis plots the positions of a plurality of photodetection elements arranged in a line, and the Y-axis plots output voltages from the respective photodetection elements. The output voltage of a photoelectric conversion element becomes higher with increasing amount of incoming light. For this reason, the output of the central portion of the waveform of the output voltage shown in FIG. 9 is set as a white reference voltage, and output voltages from all the photodetection elements must be corrected to become equal to the white reference voltage.

Hence, in step S1 the outputs from the line image sensors 171, 172, and 173 respectively undergo shading correction. More specifically, output voltages output from the respective photodetection elements of the line image sensor 171 are monitored, and the gains upon amplifying the output voltages from all the photodetection elements are controlled so that all the photodetection elements output identical voltages, as shown in FIG. 10. Likewise, the outputs from the line image sensors 172 and 173 undergo shading correction.

Such shading correction can be achieved by the signal processing circuit 30 which includes a plurality of variable-gain amplifiers, and a control circuit which monitors the outputs from the amplifiers and controls the gain of the individual amplifiers to obtain identical outputs. It is best to implement the control circuit by a microprocessor that operates based on a control program called firmware.

In step S2, the signal processing circuit 30 executes white correction by controlling the gains of the amplifiers so that the output voltages output from the line image sensors 171, 172, and 173 assume identical values. White correction adjusts the output voltages of red (R), green (G), and blue (B) color components to assume identical values, so that the color image sensor 17 generates a white output upon receiving light reflected by a white portion. As a result of white correction, voltage values are preferably standardized to those which are converted into the highest level values “255” by the A/D conversion circuit 31.

In step S3, an image of the form 18 is captured. Specifically, the surface of the form 18 is irradiated with light emitted by the white light source 16 while moving the optical head 14 within the range of the form 18 placed on the glass 12, light reflected by the surface of the form 18 is photoelectrically converted by the color image sensor 17 to obtain analog signals as output voltages of red (R), green (G), and blue (B) color components, and the obtained analog signals are amplified by the signal processing circuit 30. The analog signals amplified by the signal processing circuit 30 are converted into 256-level digital data by the A/D conversion circuit 31, and the digital data are output to the image buffer memory 32.

With this operation, the form image of the form 18 is stored as digital data in the image buffer memory 32.

In step S4, the sheet surface white level detection circuit 331 of the image processing unit 33 is enabled to detect the level of image data on a blank portion where no information is recorded at the leading end of the form 18, i.e., the white level of the sheet surface, with reference to the image data of the form 18 stored in the image buffer memory 32.

In general, the white level of the sheet surface is lower than level “220” which is the output value of white reference obtained from the A/D conversion circuit 31 after white correction in step S2. Also, the white level of the sheet surface varies depending on paper quality such as the paper thickness, paper color, and the like of the form 18. For example, assume that the white level of the sheet surface detected in step S4 falls within the range from 220 to 200, as shown in the graph of FIG. 11. In this case, level “220”, as the highest value is detected as the white level of the sheet surface, and is stored in the image processing unit 33. In FIG. 11, level “220” indicates the white level as white reference after white correction obtained in step S3 using the white reference plate 19.

In step S5, the fluorescent ink detection circuit 332 of the image processing unit 33 is enabled to detect images formed on the form 18 using fluorescent ink with reference to the image data of the form 18 stored in the image buffer memory 32.

Some specific fluorescent ink has characteristics in which when the image sensor detects visible light which is emitted by ink excited upon being irradiated with ultraviolet rays, the output level after photoelectric conversion of the image sensor is saturated and assumes a value higher than level “220”, as the white level of white reference shown in FIG. 11. This invention uses the fluorescent ink having such characteristics to detect images such as characters, figures, marks, or the like formed on the form 18 using the fluorescent ink. In this embodiment, as described above, the image buffer memory 32 stores an image of the form 18 on which characters or the like are printed using transparent fluorescent ink which is excited by near ultraviolet rays having a wavelength of, e.g., 450 nm, and emits light having a wavelength of 650 nm. The fluorescent ink used has the aforementioned characteristics.

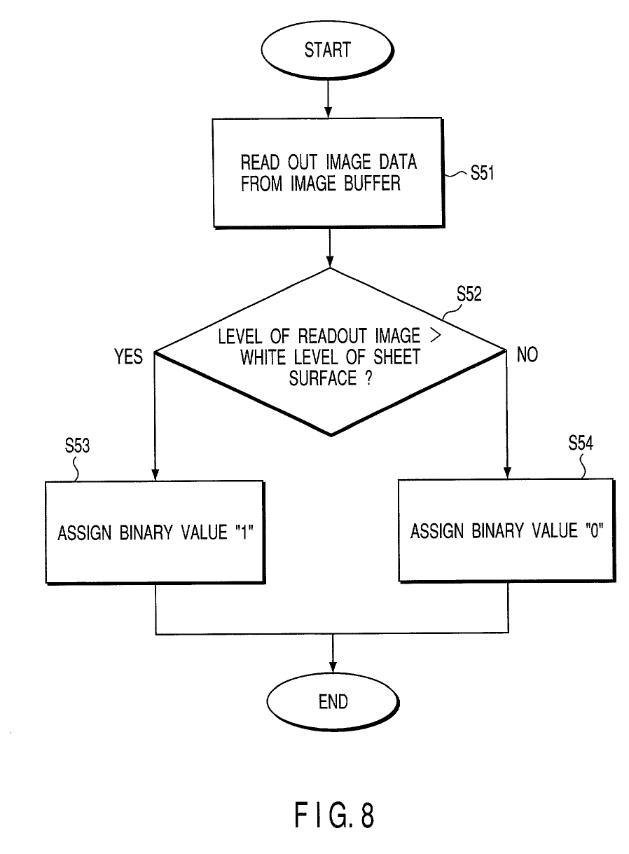

Fluorescent ink detection in step S5 will be explained below with reference to the flow chart shown in FIG. 8.

In step S51, image data of the form 18, which is obtained by A/D-converting the output voltage from, e.g., the line image sensor 171, of those stored in the image buffer memory 32 is read out.

In step S52, the level of the readout image data is compared with level “220”, as the white level of the sheet surface detected in step S3. If the level of the readout image data is higher than level “220”, a binary value “1” is assigned to the readout image data in step S53. On the other hand, if the level of the readout image data is lower than level “220”, a binary value “0” is assigned to the readout image data in step S54.

Since the readout image data is binarized based on the comparison result in step S52, an image of a character or the like formed using the fluorescent ink expressed by a binary value “1” can be detected. The image processing unit 33 transfers the detected images formed using the fluorescent ink to the character recognition unit 34.

In step S6 in FIG. 7, the character recognition unit 34 recognizes characters, figures, marks, or the like based on the image data which are obtained by binarizing the characters formed using the fluorescent ink and are transferred from the image processing unit 33. For example, if a form is recognized as being recorded using fluorescent ink by the numbering print process, the form is rejected. On the other hand, if character recognition target areas with fluorescent ink on a form are detected, the binarized image of the character recognition target areas is acquired and character recognition process is executed.

The operation shown in the flow chart in FIG. 7 is done every time one form is read. This is because the output voltages from the color image sensor 17 change due to aging and temperature characteristics, and the amount of light emitted by the white light source 16 is not constant and lowers due to aging. For these reasons, shading correction and white correction are required every time the form is read.

In the aforementioned embodiment, transparent fluorescent ink, which is excited by near ultraviolet rays and emits light having a wavelength of 650 nm, is used. However, the present invention is not limited to such specific fluorescent ink. More specifically, any other fluorescent inks may be used as long as they satisfy the following three conditions. That is, ink need satisfy: (1) it is excited by near infrared light contained in visible light output from the white light source; (2) the wavelength of visible light emitted upon exciting it has one of the three wavelengths enumerated below; and (3) the output level of a voltage output from the image sensor that detects visible light emitted by exciting the ink assumes a value higher than the white level as white reference.

The three wavelengths in condition (2) include a wavelength (e.g., around 450 nm) which can be detected by the line image sensor 171 for detecting a red color component, a wavelength (e.g., around 540 nm) which can be detected by the line image sensor 172 for detecting a green color component, and a wavelength (e.g., around 430 nm) which can be detected by the line image sensor 173 for detecting a blue color component.

When fluorescent ink that emits visible light of a wavelength which can be detected by the line image sensor 172 for detecting a green color component is used, an image must be detected based on image data output from the line image sensor 172 for detecting a green color component. Likewise, when fluorescent ink that emits visible light of a wavelength which can be detected by the line image sensor 173 for detecting a blue color component is used, an image must be detected based on image data output from the line image sensor 173 for detecting a blue color component.

In the description of the above embodiment, transparent ink which is invisible to a human is used. However, the present invention is not limited to such specific ink. That is, ink visible to a human may be used by adding a pigment depending on applications.

In the present invention, white correction in step S2 is not always indispensable. If the color image sensor 17 is used to read a color image, white correction is indispensable, but if the color image sensor 17 is used to read only an image formed using fluorescent ink, only shading correction is required.

In this embodiment, the flatbed type scanner apparatus is used. However, the present invention is not limited to such specific scanner apparatus. For example, a scanner apparatus which stacks a plurality of forms to be read on a hopper, and feeds the forms one by one from the hopper may be used.

When the color image sensor 17, signal processing circuit 30, A/D conversion circuit 31, buffer memory 32, and image processing unit 33 shown in FIG. 5 are included in the scanner apparatus, an information acquisition apparatus that acquires information from a form on which information is recorded using fluorescent ink can be constituted.

As described in detail above, according to the present invention, characters and marks formed using fluorescent ink can be detected and recognized without using any special components such as a special light source for emitting ultraviolet light, an optical filter for intercepting transmission of ultraviolet light, or the like. Moreover, it is possible to execute numbering print process and limit recognition target areas using fluorescent ink, without making forms dirty.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method of acquiring information from a form on which the information is recorded using fluorescent ink, comprising the steps of:
irradiating the form with light which is emitted by a white light source, the light containing near ultraviolet light;
outputting an analogue signal according to an amount of light reflected by the form;
converting the output analogue signal into a multi-level digital signal;
detecting from the digital signal a reference level of the digital signal corresponding to a position of the form where no information is recorded; and
comparing a level of the digital signal corresponding to the information recorded using fluorescent ink with the reference level, and binarizing the digital signal based on a result of the comparison to obtain image information.

2. The method according to claim 1, wherein the step of detecting the reference level comprises a step of detecting white level of the digital signal corresponding to a white surface of the form where no information is recorded.

3. An apparatus for acquiring information from a form on which the information is recorded using fluorescent ink, comprising:
a white light source for irradiating the form with light containing near ultraviolet light;
photoelectric conversion means for outputting an analogue signal according to an amount of light reflected by the form;
A/D conversion means for converting the output analogue signal into a multi-level digital signal;
reference level detection means for detecting from the digital signal a reference level of the digital signal corresponding to a position of the form where no information is recorded; and
binarization means for comparing a level of the digital signal corresponding to the information recorded using fluorescent ink with the reference level, and binarizing the digital signal based on a result of the comparison to obtain image information.

4. The apparatus according to claim 3, wherein said reference level detection means detects white level of the digital signal corresponding to a white surface of the form where no information is recorded

5. The apparatus according to claim 3, wherein said photoelectric conversion means comprises a sensor having a plurality of photodetection elements for outputting signals according to the amount of the reflected light, and said apparatus further comprises:
voltage adjustment means for amplifying output signals output from said sensor and outputting the amplified output signals to said A/D conversion means; and
control means for controlling said voltage adjustment means so as to make voltages of output signals of all the photodetection elements of said sensor equal to a predetermined voltage when a reference surface in white is irradiated with light emitted by said white light source and light reflected by the reference surface is input to said sensor.

6. The apparatus according to claim 3, wherein:
said photoelectric conversion means comprises a color image sensor having a red sensor which has a plurality of photodetection elements for outputting signals according to an amount of red light in the reflected light, a green sensor which has a plurality of photodetection elements for outputting signals according to an amount of green light in the reflected light, and a blue sensor which has a plurality of photodetection elements for outputting signals according to an amount of blue light in the reflected light, and
said A/D conversion means converts an analogue signal output from one of the red, green, and blue sensors into the digital signal.

7. A character recognition apparatus for recognizing characters from a form on which the characters are recorded using fluorescent ink, comprising:
a white light source for irradiating the form with light containing near ultraviolet light;
photoelectric conversion means for outputting an analogue signal according to an amount of light reflected by the form;
A/D conversion means for converting the output analogue signal into a multi-level digital signal;
reference level detection means for detecting from the digital signal a reference level of the digital signal corresponding to a position of the form where no information is recorded;
binarization means for comparing a level of the digital signal corresponding to the information recorded using fluorescent ink with the reference level, and binarizing the digital signal based on a result of the comparison to output image information; and
recognizing means for recognizing the form as being recorded using the fluorescent ink based on the image information output from said binarization means.

8. A character recognition apparatus for reading characters from a form on which the characters are recorded and recognizing the read characters, comprising:
fluorescent ink detection means for detecting whether or not one of a character and a mark is recorded on a form using the fluorescent ink; and
rejecting the form in a case where said fluorescent ink detection means detects that the one of the character and mark is recorded on the form using the fluorescent ink.

9. The apparatus according to claim 8, further comprising:
a light source for emitting near ultraviolet light to read the one of the character and mark recorded on the form;
an image sensor for sensing a reflected light from the form; and
white level detection means for detecting the one of the character and mark recorded on the form in a case where an output level of said image sensor is higher than a white level of the form.

10. The apparatus according to claim 9, wherein said white level detection means and said fluorescent ink detection means are incorporated in an image processing unit of the apparatus.

11. The apparatus according to claim 7, further comprising reject means for rejecting the form recognized by said recognizing means.

12. The apparatus according to claim 7, further comprising means for executing character recognition for one or more target lines with fluorescent ink on the form recognized by said recognizing means.
